(19) United States
(12) Patent Application Publication
(10) Pub. No.: US 2004/0264189 A1
(43) Pub. Date: Dec. 30, 2004

(54) LED spotlight (type II)

(76) Inventors: Kuo-Fen Shu, Hsinchu City (TW); Chung Zon Wong, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/607,988

(22) Filed: Jun. 30, 2003

(51) Int. Cl. F21S 2/00

(52) U.S. Cl. 362/257

(57) ABSTRACT

The present invention relates to a LED spotlight (type II), which includes a lampshell, heat-remover, and a light-collecting cover, wherein the cover has its bottom provided with an aperture to engage with a LED. The light-collecting cover is capable of reflecting and concentrating the light emitted from the LED to a same direction that provides an efficient spotlight. An IC board is provided in the shell on the bottom of the heat-remover and is electrically connected with the LED to transform input AC current to DC current for easy use.

### BACKGROUND OF THE INVENTION

A conventional spotlight mainly includes a shell, a tungsten bulb provided therein, and a glass cover. By use of lighting of the tungsten bulb and reflection from inner curved face of the shell, the most light can be emitted forward concentratively. The known spotlight has following drawbacks:

1. The tungsten bulb has a large volume and occupies large space in the shell. It reduces the reflective effect of lighting.

2. The tungsten bulb needs large power and leads high heat. It will be more possible to cause a fire in accident.

3. It is necessary to use an extra transformer to light the tungsten bulb.

4. The tungsten is easily broken and has a short used period.

Accordingly, the present invention is to overcome the drawback of the conventional product and to provide a LED spotlight, which uses LED and a light-collecting cover to emit light concentratively, and it can be used for a long term and low power needed.

### BRIEF DESCRIPTION OF THE DRAWINGS

The following drawings indicate the character and improvement of the present invention.

FIG. 1 shows an exploded perspective view of a LED spotlight according to the present invention.

FIG. 2 shows an assembled perspective view of FIG. 1.

FIG. 3 shows a cross-sectional plan view of FIG. 2.

FIG. 4 shows an outlet of the circuit according to the present invention.

### DETAILED DESCRIPTION OF THE INVENTION

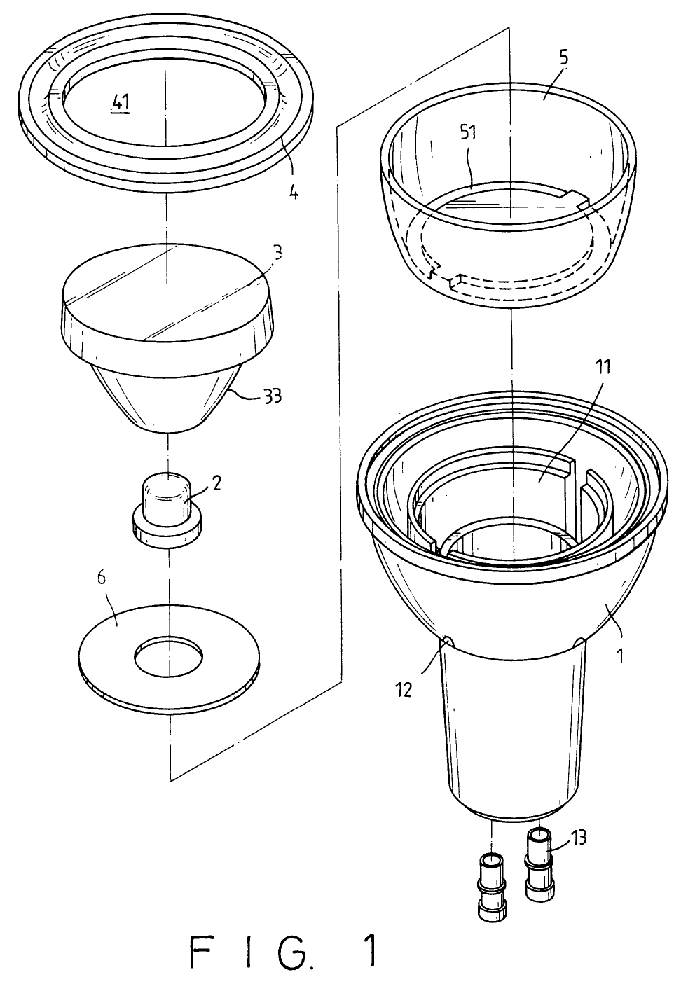

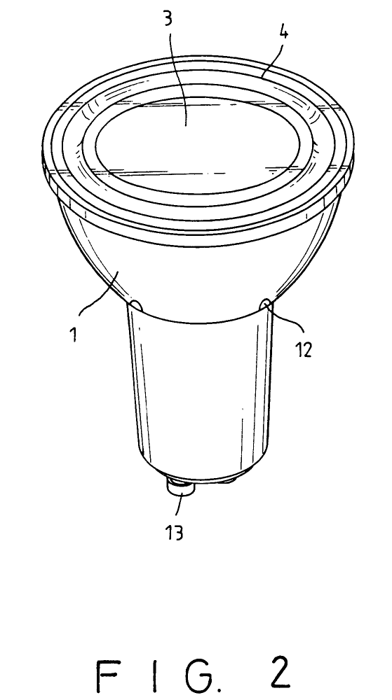

Please referring to FIG. 1 to 3, the present invention relates to an improvement of a spotlight, which includes a lampshell (1), a LED (2), a light-collecting cover (3), and a cap (4). The lampshell (1) can be provided with a connecting ring (11) to engage with the light-collecting cover (3). Several vents (12) can be formed on the lampshell (1). The light-collecting cover is a transparent solid body and has its side being a paraboloid (33). An aperture (31) is formed at bottom side of the cover (3) while a convex (32) is formed therein. A plane (34) is on top of the cover (3). The LED (2) can be connected within the aperture (31). The cap (4) is assembled on the lampshell (1) and the top of the light-collecting cover (3) is engaged within central hole (41) of the cap (4). A heat-remover (5) is provided in the shell (1), which has a ring-type groove (51) at its bottom for engaging with the connecting ring (11). An IC board (6) is provided on the bottom of the heat-remover (5), which is electrically connected with the LED (2). FIG. 4 shows an embodiment of the circuit of the IC board (6), which includes several transistors D1˜D4 to transform input AC current from electrical rods (13) on the shell (1) to DC current for LED (2).

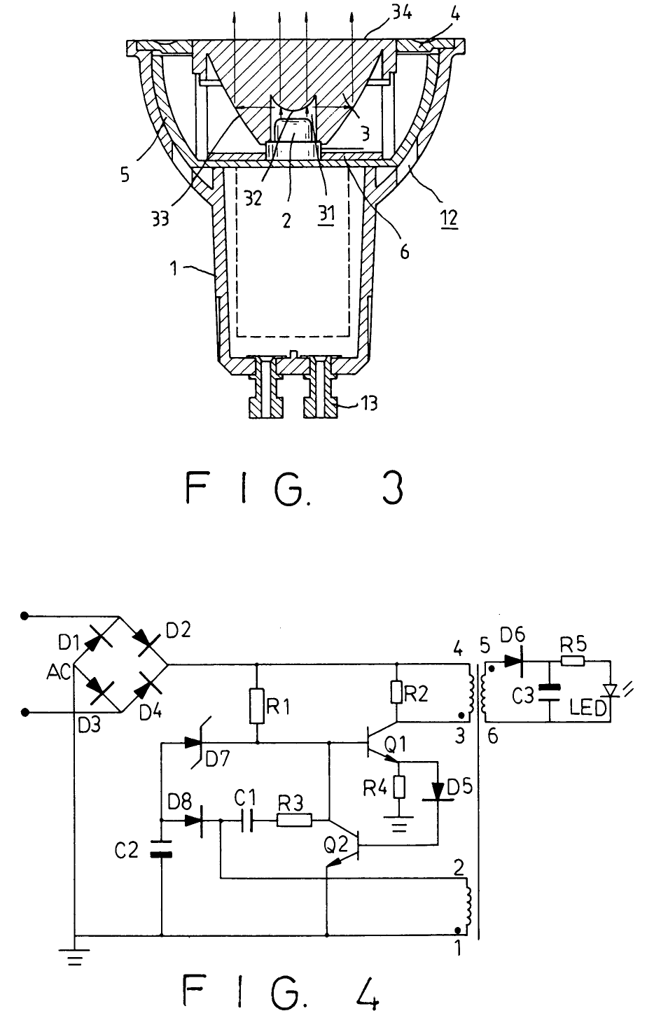

In use, when the LED (2) is lighting, the light can be emitted concentratively forward in the arrow direction as shown in FIG. 3, because of the light-collecting cover (3) and its side paraboloid (33) to reflecting the light efficiently. Hence, the LED spotlight obtains a perfect light effect. At the same time, the heat-remover (5) contacts the IC board (5) directly that can reduce the temperature in the shell (1) efficiently.

Accordingly, based on the novel design of the present invention, which uses the IC board to transform the electrical current for easy use of LED and uses the light collecting cover to provide a well effect for concentrating the light and reaches an excellent spotlight. That obtains improvement and utility.

What is claimed is:

1. A LED spotlight (type II) including a lampshell, a LED, a light-collecting cover, and a cap, wherein the lampshell can be provided with a connecting ring to engage with the light-collecting cover and several vents can be formed on the lampshell; the light-collecting cover being a transparent solid body and has its side being a paraboloid, while an aperture is formed at bottom side of the cover and a convex is formed therein; the LED being connected within the aperture, the cap being assembled on the lampshell, and the top of the light-collecting cover is engaged within central hole of the cap; a heat-remover being provided in the shell, which has a ring-type groove at its bottom for engaging with the connecting ring and an IC board being provided on the bottom of the heat-remover, which is electrically connected with the LED, wherein the circuit of the IC board being capable of transforming input AC current from electrical rods on the shell to DC current for LED.
